(19) United States
(12) Patent Application Publication
(10) Pub. No.: US 2012/0177955 A1
(43) Pub. Date: Jul. 12, 2012

(54) BATTERY WITH RESETTABLE INTERNAL FUSE

(75) Inventor: Erling J. AUNE, JR., Vancouver, WA (US)

(73) Assignee: International Rehabilitative Sciences, Inc., Vancouver, WA (US)

(21) Appl. No.: 12/985,889

(22) Filed: Jan. 6, 2011

(51) Int. Cl. H01M 10/50

(52) U.S. Cl. 429/50; 429/62

(57) ABSTRACT

A 9V battery has a fuse such as a 1 amp bi-metallic resettable fuse in series with the battery cells. This would prevent over-current conditions from occurring, keeping the battery from overheating and prolonging the useful life of the battery. Once the fuse is reset, the battery is once again usable.

### FIELD OF THE INVENTION

The present invention is directed to an electrical battery, such as a nine-volt (9V) battery, and more specifically to a battery with a resettable internal fuse.

### DESCRIPTION OF RELATED ART

A 9V nickel metal hydride (NiMH) battery contains seven individual 1.2V cells wired in series to develop a nominal operating voltage of 8.4V, although peak voltage can be higher. A fully charged 200 mahr rated battery can produce over two amperes of current and will physically heat up from the rapid discharge of stored energy. Typically, 9V batteries are used in low-current applications such as transistor radios, as they are suited for small, portable, low-current devices.

A 9V rechargeable transistor battery has two large exposed terminals that are easily shorted together when allowed to come in contact with metal objects like keys or coins in a person's pocket or purse. Batteries that are fully charged contain enough energy to heat up to over 350 degrees Fahrenheit (see FIG. 1), which can cause third-degree burns if allowed to come into contact with human skin. Also, the battery becomes permanently damaged if allowed to overheat and if cell voltages drop below critical levels.

To address the above concerns, it is known in the art to incorporate a thermal fuse into a battery to prevent overheating in the case of a short circuit. Examples are shown in U.S. Pat. Nos. 4,075,400, 4,719,159, 4,741,979, and 6,377,432 and in U.S. Patent Application Publication No. 2010/0067173. However, the fuses taught in those references operate by destroying either the fuse or the entire battery and are thus wasteful. U.S. Patent Application Publication No. 2009/0045944 includes a passing mention of a fuse in a battery, but does not explain how the fuse works and therefore does not overcome the above-noted deficiencies of the other references.

### SUMMARY OF THE INVENTION

It will be apparent that a need exists in the art for a non-wasteful way to protect against battery overheating caused by short-circuiting.

It is therefore an object of the invention provide a way to disable a battery when it is short-circuited and then to restore the battery to operational condition once the cause of the short circuit is removed.

To achieve the above and other objects, the present invention is directed to a battery containing a fuse capable of being reset, e.g., to a 9V battery having a fuse such as a 1 amp bimetallic resettable fuse in series with the battery cells. The fuse prevents over-current conditions from occurring, keeping the battery from overheating and prolonging the useful life of the battery. Once the fuse is reset, the battery is once again usable.

### BRIEF DESCRIPTION OF THE DRAWINGS

A preferred embodiment of the present invention will be set forth in detail with reference to the drawings, in which:

FIG. 1 is a graph showing temperature as a function of time when a conventional fully charged 180 maHr NiMH 9V battery is short-circuited;

FIG. 2 is a schematic diagram of a battery according to the preferred embodiment; and

FIGS. 3 and 4 are graphs showing the operation of the battery of FIG. 2 when it is short-circuited.

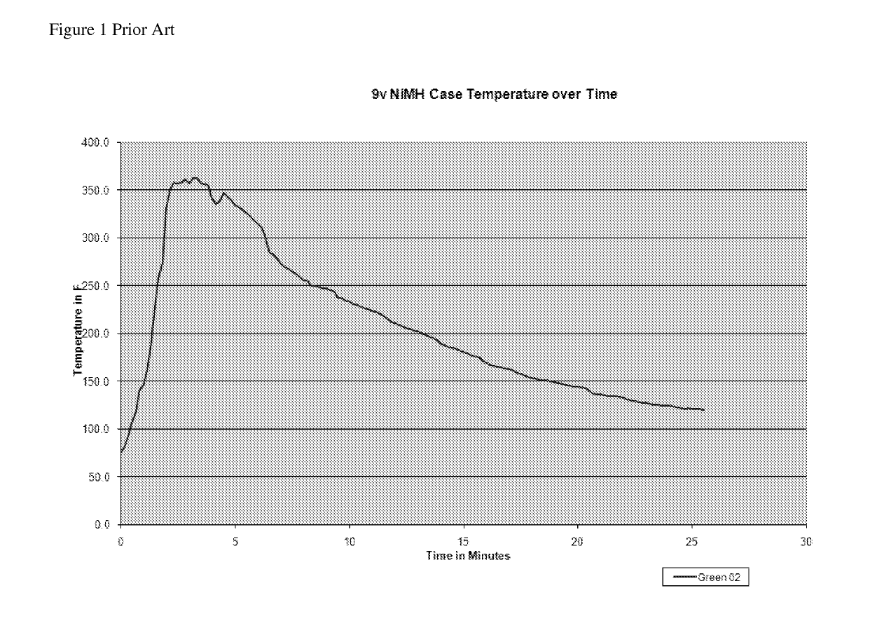

### DETAILED DESCRIPTION OF THE PREFERRED EMBODIMENT

A preferred embodiment of the present invention will be set forth in detail with reference to the drawings, in which like reference numerals refer to like elements throughout.

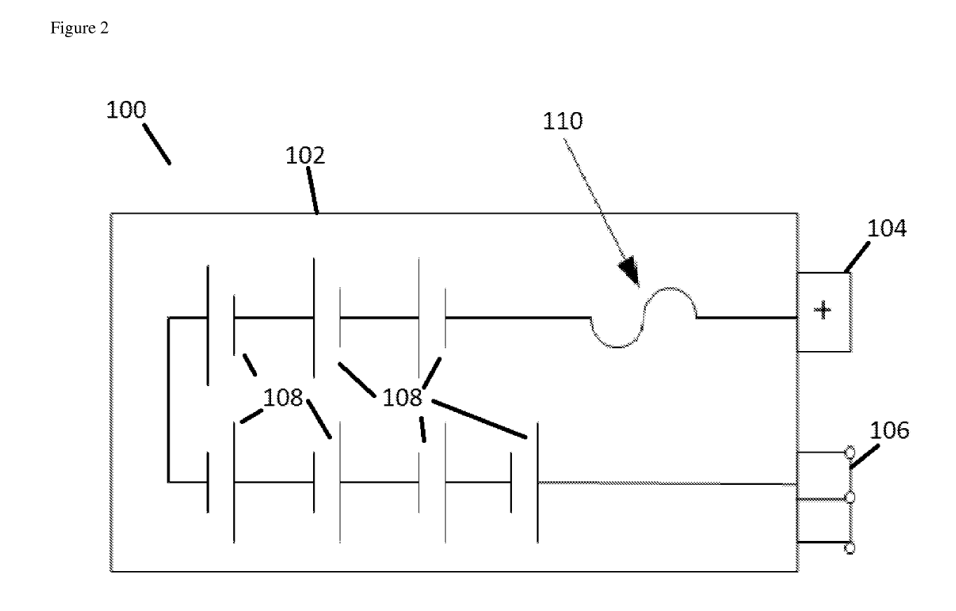

As shown in FIG. 2, a battery 100 according to the preferred embodiment includes the following conventional components: a container 102, a positive terminal 104, a negative terminal 106, and seven cells 108 in series. However, the battery also includes a bimetallic fuse 110 in series between the positive terminal 104 and the cells 108.

The bimetallic fuse 110 in the preferred embodiment is constructed to open in the case of a short circuit causing excessive temperature and to close again once the short circuit is removed. As is well known in the art, a bimetallic fuse has two or more metal layers with different coefficients of thermal expansion, so that it changes shape when heated and reverts to its original shape when cooled. Thus, the fuse automatically resets itself once the cause of the short circuit is removed.

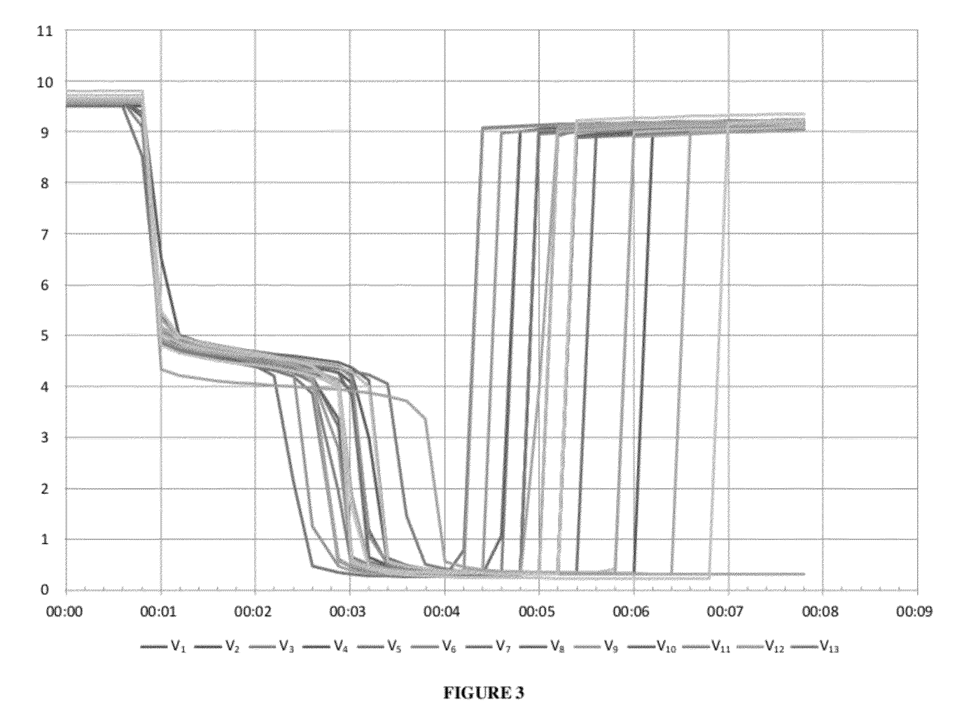

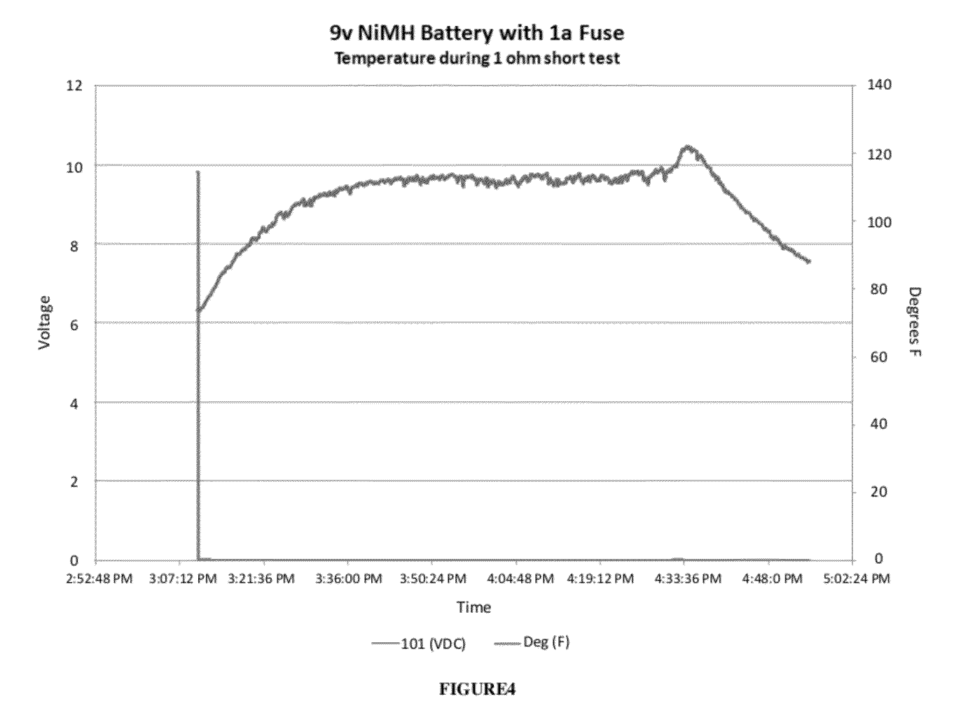

A fully charged 9V NiMH battery will read over 9 volts without a load (open circuit). As soon as the terminals are shorted (a 1 ohm resistor was used to short the terminals in order to view the voltage drop), the voltage drops to around 4.5 volts for approximately 2 seconds. That allows the bimetallic fuse 110 to heat up and open, bringing the voltage (and current) to near zero. The voltage and temperature over time are shown in FIGS. 3 and 4. When the short is removed, the fuse returns to its original state, and the voltage returns to operating potential without heating up the battery or damaging the cells.

Adding a 1-amp bimetallic fuse inside of a 9V NiMH battery protects the battery cells if they are momentarily shorted together and eliminates the burn hazard currently exhibited in such batteries.

While a preferred embodiment has been set forth in detail above, those skilled in the art who have reviewed the present disclosure will readily appreciate that other embodiments can be realized within the scope of the invention. For example, the invention is not limited to 9V batteries. Also, the fuse can be any suitable fuse capable of being reset, either automatically or manually, and can be electrically connected in any suitable location. Therefore, the present invention should be construed as limited only by the appended claims.

1. A battery comprising:
a battery container;
a plurality of terminals on the battery container;
at least one battery cell in the battery container; and
a fuse electrically connected to the at least one battery cell and the plurality of terminals, the fuse being configured to disable the battery when the battery is short-circuited and to re-enable the battery when the battery is no longer short-circuited.

2. The battery of claim 1, wherein the fuse comprises a thermal fuse.

3. The battery of claim 2, wherein the thermal fuse comprises a bimetallic fuse.

4. The battery of claim 1, wherein the fuse is connected in series between the at least one battery cell and one of the terminals.

5. The battery of claim 1, comprising a plurality of said battery cells.

6. The battery of claim 5, wherein the fuse is connected in series between the plurality of said battery cells and one of the terminals.

7. The battery of claim 6, wherein the battery is a nine-volt battery.

8. The battery of claim 5, wherein the fuse and all of the battery cells are connected in series between the terminals.

9. The battery of claim 8, wherein the plurality of terminals comprise a positive terminal, and wherein the fuse is connected in series between the positive terminal and one of the plurality of battery cells.

10. The battery of claim 5, wherein the plurality of battery cells are connected in series.

11. The battery of claim 5, wherein the plurality of battery cells are nickel-metal-hydride (NiMH) battery cells.

12. The battery of claim 3, wherein the fuse is a 1-amp fuse.

13. A method for protecting a battery from overheating due to a short circuit, the method comprising:
(a) providing, in the battery, a battery container, a plurality of terminals on the battery container, at least one battery cell in the battery container, and a fuse electrically connected to the at least one battery cell and the plurality of terminals, the fuse being configured to disable the battery when the battery is short-circuited and to re-enable the battery when the battery is no longer short-circuited;
(b) causing the fuse to disable the battery when the battery is short-circuited; and
(c) causing the fuse to re-enable the battery when the battery is no longer short-circuited.

14. The method of claim 13, wherein the fuse comprises a thermal fuse.

15. The method of claim 14, wherein the thermal fuse comprises a bimetallic fuse.

16. The method of claim 13, wherein the fuse is connected in series between the at least one battery cell and one of the terminals.

17. The method of claim 13, wherein the battery comprises a plurality of said battery cells.

18. The method of claim 17, wherein the fuse is connected in series between the plurality of said battery cells and one of the terminals.

19. The method of claim 18, wherein the battery is a nine-volt battery.

20. The method of claim 17, wherein the fuse and all of the battery cells are connected in series between the terminals.
